(19) United States
(12) Patent Application Publication
(10) Pub. No.: US 2016/0113242 A1
(43) Pub. Date: Apr. 28, 2016

(54) THERMOPLASTIC STONE BONE

(71) Applicant: Steve Brian LACASSE, Port Saint Lucie, FL (US)

(72) Inventor: Steve Brian LACASSE, Port Saint Lucie, FL (US)

(21) Appl. No.: 14/521,775

(22) Filed: Oct. 23, 2014

(51) Int. Cl. A01K 11/00; A23K 1/18; A23K 1/14

(52) U.S. Cl. CPC A01K 15/026; A23K 1/14; A23K 1/1893; A23K 1/1846

(57) ABSTRACT

A teething toy for animals is provided. The teething toy may be molded into a desired configuration from a stone composition 10 comprises tricalcium silicate and dicalcium silicate wherein the weight ratio is within the range of about 4:1 to about 2.5:1, whereby the stone composition 10 has an identifiable natural stone scent that triggers a dog's genetic response relative to teething pain relief, causing the dog to crave chewing. Certain embodiments of the present invention further comprise a grass composition, wherein the grass composition includes Chlorophyllin, turf grass or a combination thereof.

### BACKGROUND OF THE INVENTION

The present invention relates to animal chew toys and, more particularly, to an animal chew toy formed from a composition for controllably triggering and satisfying the animal's instinctual teething.

Dogs are direct descendants of wolves separated by over 18,000 years of evolution. Domesticated cats are descendants of African Wild Cats separated by over 10,000 years of evolution. Passed down generation to generation are natural genetic instincts and traits, in particular, the ones that influence teething pain and upset stomach behavior.

Puppies are initially born without teeth. They do not receive their first puppy teeth until they reach the age of between six and eight weeks. They grow a total of 28 teeth, which are known as baby teeth or deciduous teeth. The first teeth that fall out are the incisor teeth, followed by the premolars and the canines. For puppies, the teething process continues for several months, an uncomfortable and very painful period. When puppies are teething, they increase their biting and chewing testing out different objects and textures to relieve the pain and discomfort. Between the ages of three and seven months, a puppy begins to lose its deciduous teeth. Each deciduous tooth root will generally be absorbed by the adult tooth. At three months, the incisors begin to fall out to make room for the new adult teeth. At the age of four months, the adult molars and adult canines are beginning to come in. Between the ages of six and seven months, the adult molars will come in. Finally, by seven to eight months, the full set of approximately forty-two adult teeth should have come in.

During the puppy stage all dogs experience teething pain. The teething pain triggers a dog's natural inherited genetic instinct for pain relief to chew, sometimes referred to as “teething.” If not addressed a potential lifetime of chewing bad habits may develop.

A dog in search of and desperate for teething pain relief will chew all that is available, more precisely, from a shoe to a couch. Dogs that have outdoor access have frequently been known to chew on stone and even swallow rocks requiring surgical removal. It's long been known that dogs will and do gnaw and chew on stone and rock etc.

This instinctive natural behavior helps relieve pain and expedites the teething process. Industry research usually misattributes rock chewing or ingesting to a nutritional deficiency, Pica, anxiety, and or brain disease. To a pet-owner, a dog chewing or gnawing on stone is attributed to nothing more than peculiar behavior. Recognition of this behavior and identifying its purpose led to the development of the present invention.

Similarly, most experts agree that grazing is not harmful for household pets, such as dogs and cats; however, certain pesticides and herbicides used for lawn treatment can be quite toxic, especially if ingested. In 2008, fertilizers were one of the top ten causes of pet poisoning. It is highly advisable that dogs and cats have access to turf-type grasses that have not been chemically treated.

All prior art share the same approach to the teething pain chewing problem, however, utilizing different methods of impregnating or coating a natural or synthetic dog chew toy with a palatable, flavorful and appetizing additive. Nylon and polyurethane dog chew toys have been around for over fifty years, yet they still may be harmful and even fatal. Over the past fifty years prior art in the pet chew toy industry has never made an attempt to change the physical properties of the nylon thermoplastic material, which notoriously interacts with dog canines and molars to create grooves with raised sharp razor edges responsible for gum bleeding, gum infection, digestive track lacerations and polyurethane-related for digestive track lodging. The design changes that have occurred to date include coating, impregnating, encapsulating or otherwise incorporating a flavorful, palatable additive with a thermoplastic resin, usually nylon or polyurethane. These additives do not change the physical properties of the thermoplastic material; therefore, the potential harmful and fatal side effects still exist.

As can be seen, there is a need for a safe animal chew toy that controllably triggers and satisfies the animal's instinctual teething.

### SUMMARY OF THE INVENTION

In one aspect of the present invention, a non-edible teething toy for animals molded into a desired configuration from a stone composition 10 comprises tricalcium silicate and dicalcium silicate wherein the weight ratio is within the range of about 3:1 to about 2:1.

In yet another aspect of the present invention, a method of making a teething toy for an animal which is effective in triggering the teething instinct of the animal, comprises the steps of: forming of a thermoplastic blend comprising: a first material selected from the group consisting of tricalcium silicate and dicalcium silicate and a combination thereof; and a thermoplastic resin; wherein the weight ratio of said thermoplastic resin and said first material is about 2:1; molding the thermoplastic blend into a desired configuration; and curing the thermoplastic blend.

In another aspect of the present invention, a teething toy for animals formed of a thermoplastic blend comprises: a first material selected from the group consisting of tricalcium silicate and dicalcium silicate and a combination thereof; and a thermoplastic resin; wherein the weight ratio of said thermoplastic resin and said first material is about 2:1. Certain aspects of the present invention further comprise a grass composition, wherein the grass composition may include Trisodium Copper Chlorin e6, Disodium Copper Chlorin e4, turf grass or a combination thereof providing a chew toy.

In yet another aspect of the present invention, a method of an edible chew toy for an animal which is effective in providing upset stomach relief for the animal, comprises the steps of forming and curing an edible blend selected from the group consisting of turf grass and a starch and a gelatin, wherein the weight ratio of said turf grass and starch or gelatin is about 9:1. Certain aspects of the present invention further comprise the edible chew toy formed by the method of making an edible chew toy for an animal which is effective in providing upset stomach relief, wherein the resulting edible chew toy is in the configuration of a rope.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of a non-edible configuration of the present invention;

FIG. 2 is a perspective view of an exemplary embodiment of the present invention;

FIG. 3 is a perspective view of an exemplary embodiment of the present invention;

FIG. 4 is a perspective view of an exemplary embodiment of the present invention; and

FIG. 5 is a perspective view of an exemplary embodiment of an edible configuration of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a teething chew toy for animals that may be molded into a desired configuration from a stone composition comprising tricalcium silicate and dicalcium silicate wherein the weight ratio is within the range of about 3:1 to about 2:1, whereby the stone composition has an identifiable natural stone scent that triggers a dog's genetic response relative to teething pain relief, causing the dog to crave chewing. Certain embodiments of the present invention may further comprise a thermoplastic resin, a grass composition, or a combination thereof.

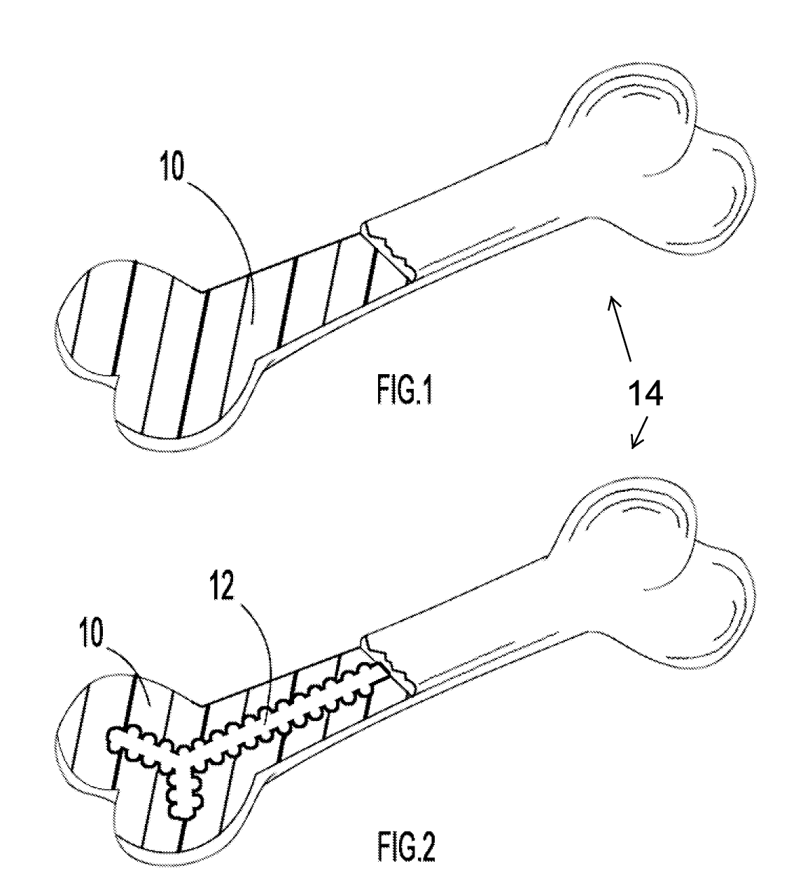

Referring to FIGS. 1 and 2, the present invention may include a non-edible teething chew toy 14. The teething chew toy 14 may be of any suitable size necessary to accommodate all breeds. The teething chew toy 14 may be of any suitable or desired shape to attract all breeds or be aesthetically pleasing to their owners, for example, but not limited to, the shape of a bone, stick, ball, boomerang, rope or the like. The teething chew toy 14 may be formed in any suitable way, including but not limited to molding, casting, or the like.

The teething chew toy 14 may be made of a triggering composition having an identifiable natural stone scent that triggers a dog's genetic response relative to teething pain relief, causing the dog to crave chewing.

The triggering composition may be comprised of a stone composition 10 of generally pulverized sand and limestone. The stone composition 10 may include Tricalcium Silicate (Ca3SiO4), and Dicalcium Silicate (Ca2SiO5), with or without a minimal trace of Tricalcium Aluminate (Ca3Al2O6), Tetracalcium AluminoFerrite (Ca4Al2Fe2O10), Potassium Oxide and Sodium Oxide that may be present as a result of the manufacturing process.

In certain embodiments, the stone composition 10 may include 55% Tricalcium Silicate (Ca3SiO4), 20% Dicalcium Silicate (Ca2SiO5), 10% Tricalcium

Aluminate (Ca3Al2O6), 8% Tetracalcium AluminoFerrite (Ca4Al2Fe2O10), 2% Potassium Oxide and 1% Sodium Oxide may be blended with water creating a chemical reaction known as hydration and then cured and finished.

In some embodiments, the stone composition 10 may be 73% Alite and 27% Belite, hydrated and cured. Alite is another name for tricalcium silicate, sometimes formulated as 3CaO SiO2 or shorthand C3S. It is the most dominant element found in Portland cement, responsible for initial set and early strength gain. Belite is another name for dicalcium silicate, sometimes formulated as 2 CaO or shorthand C2S. It is the second most dominant element found in Portland cement, responsible for strength gain after one week of cure time.

The stone composition 10 is not an additive, but rather a structural material component of the teething chew toy 14 serving a dual purpose. First and foremost, having an identifiable natural stone scent that triggers and signals an inherited genetic response relative to teething pain relief for a dog to desire, crave and chew the present invention. Second, providing physical properties advantageous to the thermoplastic-based chew toys found in the prior art.

In certain embodiments, the teething chew toy 14 may provide an internal rebar 12 or other reinforcement embedded therein for carrying the tensile loads and improving the overall strength and impact resistance of the teething chew toy 14. The rebar 12 may be a thermoplastic rebar.

In an alternative embodiment, the triggering composition may be further comprised of a first blended composition 16, which may include a blend of the stone composition 10 and a thermoplastic resin, forming a thermoplastic stone bone 15. The stone composition 10 portion of the first blended composition 16 is not an additive, but rather a structural material component of the thermoplastic stone bone 15 serving a dual purpose. The resin composition may include a thermoplastic nylon resin. The first blended composition 16 maintains the amount of natural stone scent necessary to stimulate a teething dog's attraction to chew for pain relief, while dramatically increasing the thermoplastic stone bone 15 durometer and impact resistance, thereby creating a safe thermoplastic chew toy.

Moreover, the first blended composition 16 may be designed to maintain the abrasive exterior finish, which dogs and other animals may be attracted to. In some embodiments, the thermoplastic nylon resin may be blended with that stone composition 10 comprising up to 40% C3S and C2S to increase structural integrity while affording the option to adjust the abrasive exterior finish and increase the impact resistance of the thermoplastic stone bone 15. This may be accomplished by blending a weight ratio of up to 60% thermoplastic resin, preferably nylon, however, or polyurethane with up to 40% weight ratio of stone composition 10, comprising C3S and or C2S. The thermoplastic stone bone 15 comprising such first blended composition 16 may provide a responsive exterior surface. For example, after one hour of Great Dane puppy chewing the exterior surface of the thermoplastic stone bone 15 comprising the first blended composition 16, the exterior surface thereof developed an abrasive texture similar to that of medium to coarse sandpaper, combined with the natural stone scent the puppies found to be irresistible.

From a manufacturing standpoint, the first blended composition 16 has some advantages. Preferably, for the injection molding and/or extrusion processes, the first blended composition 16 may include the thermoplastic resin, not limited to, nylon or polyurethane resin blended with the stone composition 10 comprising tricalcium silicate and or dicalcium silicate. From a cost of the manufacturing standpoint, such a combination of process and composition significantly reduced cycle time.

Blending stone composition 10 with the thermoplastic resin (the first blended composition 16) facilitates the injection molding and extrusion process, resulting in a composition that takes on the advantageous physical properties mentioned above.n

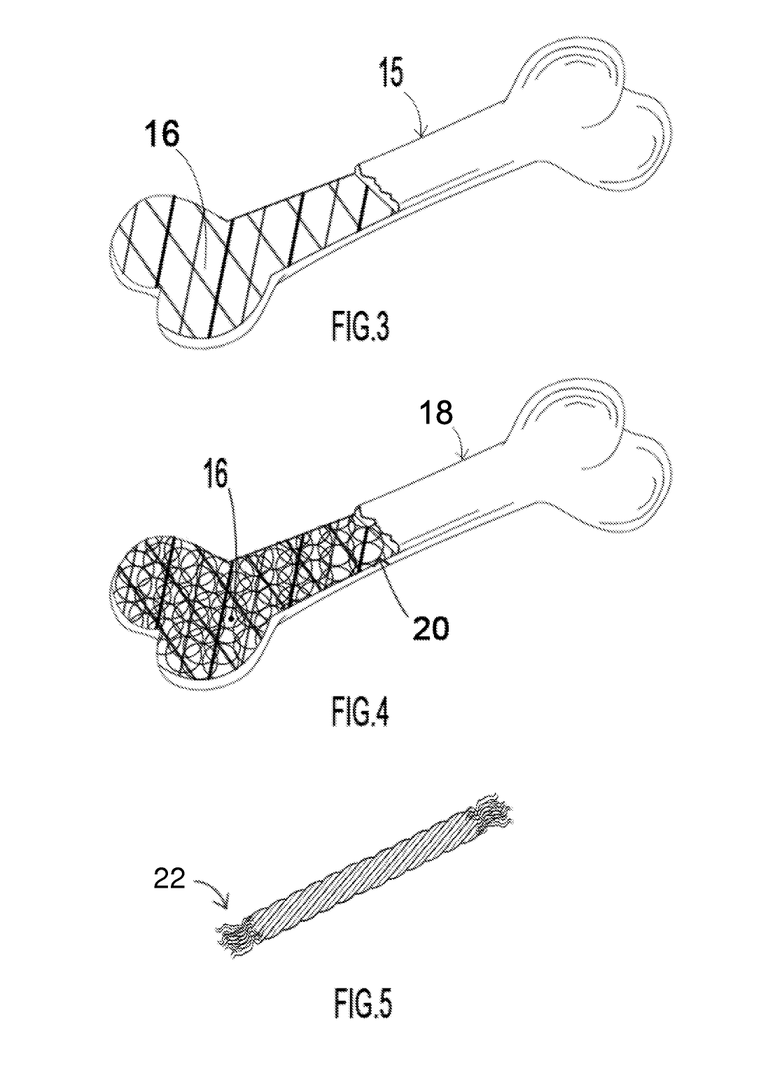

Referring to FIG. 4, the present invention may include a chew toy 18 including a second blended composition. The second blended composition may be manufactured from a grass composition 20 blended with the first blended composition 16. The grass composition 20 may be composed to satisfy an animal's craving to chew grass so as to provide a safe chew toy as opposed to the animal chewing grass containing pesticides, herbicides and the like.

The grass composition 20 may include Trisodium Copper Chlorin e6, Disodium Copper Chlorin e4, turf grass or a combination thereof. The turf grass may include blade fibrous cellulose, cellulose-based fiber or plant fiber. The blade fibrous cellulose may be provided from portions of grasses belonging to the family of Monocotyledonous flowering plants, with more than 10,000 domesticated and wild species, including economically important grasses that fall under the grain crop category include barley, oats, rice, rye and wheat etc., most of which is mentioned and most popular in the prior art, as well as the leaf and stem crop grasses that includes bamboo, reeds, ryegrass, and sugarcane etc.. However, the turf grass category, more particularly, the blade section of the turf grass from Bermuda to St. Augustine is preferred.

Plant Fiber

There may be two types of plant fiber: 1) regenerated or pure cellulose and 2) modified cellulose such as the cellulose acetates which are artificial fibers, though not truly synthetic because they are manufactured from wood. Preferably, the plant cellulose fiber utilized for the present invention is the blade section of natural turf grass. Mature turf grass is made-up of the following above ground components; the stolon, budleaf, collar, midrib, sheath, auricles, ligule, blade and seedhead. However, the preferred edible section to both dogs and cats is the blade. Cellulose fibers are fibers from some plant or plant based materials that are usually categorized as “natural” or “manufactured”. The natural cellulose fibers such as the natural turf grass blade utilized for the present invention may be natural turf grass blades that are still recognizable as being from a part of the original turf grass because they are processed only as much as needed to prepare the blades for production use. Notably, prior art shows when plant fiber is referenced it is usually vegetable fiber.

Chlorophyll

There are two types of chlorophyll found in plants, Chlorophyll a and Chlorophyll b, neither of which is very stable, and they both happen to be extremely expensive. However, there is an alternative to Chlorophyll, it is known as Chlorophyllin. Chlorophyllin or Trisodium Copper Chlorin e6, Disodium Copper Chlorin e4 or combinations thereof are the compound utilized and blended into the present invention. Chlorophyllin is a semi-synthetic mixture of water soluble sodium copper salts derived from Chlorophyll. Unlike natural Chlorophyll, Chlorophyllin is water-soluble, easier to digest, and much more stable. The content of different Chlorophyllin mixtures may vary, two compounds most commonly found in commercial Chlorophyllin mixtures are Trisodium Copper Chlorin e6 and Disodium Copper Chlorin e4. The present invention may include Chlorophyllin, and may include Trisodium Copper Chlorin e6 or Disodium Copper Chlorin e4, or a combination thereof. Most of the Chlorophyll supplements sold over-the-counter for people actually contain Chlorophyllin.

As illustrated in FIG. 4, the chew toy 18 may include the second blended composition having chlorophyllin and or turf grass blended with the thermoplastic resin containing pulverized sand and limestone. In certain embodiments, the grass composition may provide up to 10% weight ratio of chlorophyllin and or up to 30% turf grass of the second blended composition. In such an embodiment, the stone composition may provide 30% weight ratio and the remaining provided by the thermoplastic resin. The addition of up to 30% stone composition may be necessary to change the physical properties of the thermoplastic to make it a safe chew toy, and eliminate the sharp exterior knife blade edge affiliated with nylon injection molded pet chew toy products that always appear after exposure to chewing, and to eliminate the crumbling associated with polyurethane chew toys.

A method of using the present invention may include the following. The teething toy 14 and the thermoplastic stone bone 15 disclosed above may be provided. The teething toy 14 or the thermoplastic stone bone 15 is preferably introduced to the teething animal during the initial teething stage at three months of age.

In yet another embodiment, referring to FIG. 5, the present invention may include an edible chew toy 22 formed from the grass composition 20 to provide upset stomach relief for dogs and cats. During the study, dogs and cats had access to four varieties of turf grass, and the opportunity to ingest a sufficient amount of turf grass to induce vomiting. Visual observations of the regurgitation revealed and confirmed that only the whole blade portion of the turf grass was ingested. The grass composition 20 containing whole blade turf grass cellulose fiber and Trisodium Copper Chlorin e6 and or Disodium Copper Chlorin e4 is blended with a natural starch and water or a gelatin, both of which act as a binder only. The starch includes corn, potato, wheat or rice, and a combination of these and other preferably natural unmodified starches. In order to facilitate upset stomach relief, the edible treat requires up to 70% turf grass whole blade fiber cellulose between one and two inch length, up to 8% Trisodium Copper Chlorin e6 and or Disodium Copper e4, up to 10% starch, and 12% moisture then cured, or replace the starch and moisture with up to 25% gelatin and cure.

It should be understood, of course, that the foregoing relates to exemplary embodiments of the invention and that modifications may be made without departing from the spirit and scope of the invention as set forth in the following claims.

What is claimed is:

1. A teething chew toy for animals formed into a desired configuration from a stone composition comprising tricalcium silicate and dicalcium silicate wherein the weight ratio is within the range of about 4:1 to about 2:1.

2. The teething chew toy as recited in claim 1, further providing a rebar embedded within the desired configuration.

3. The teething chew toy as recited in claim 2, wherein the desired configuration is a bone.

4. A teething chew toy for animals formed into a desired configuration from a thermoplastic blend comprising: a first material selected from the group consisting of tricalcium silicate and dicalcium silicate and a combination thereof; and a thermoplastic resin; wherein the weight ratio of said thermoplastic resin and said first material is about 2:1.

5. The teething chew toy as recited in claim 4, wherein the thermoplastic resin comprises nylon resin.

6. The teething chew toy as recited in claim 4, wherein the thermoplastic resin comprises polyurethane resin.

7. The teething chew toy as recited in claim 4, wherein the desired configuration is a bone.

8. The teething chew toy as recited in claim 4, further comprising a grass composition becoming a chew toy.

9. The chew toy as recited in claim 8, wherein the weight ratio of said grass composition to said thermoplastic blend is between 10 and 50 percent grass composition to between 50 and 90 percent thermoplastic blend.

10. The chew toy as recited in claim 8, wherein the grass composition comprises Chlorophyllin.

11. The chew toy as recited in claim 8, wherein Chlorophyllin is selected from the group consisting of Trisodium Copper Chlorin e6 and Disodium Copper Chlorin e4 and a combination thereof.

12. The chew toy as recited in claim 8, wherein the grass composition comprises turf grass.

13. The chew toy as recited in claim 9, wherein the grass composition comprises a combination of Chlorophyllin and turf grass.

14. The chew toy as recited in claim 13, wherein the weight ratio of said turf grass and said Chlorophyllin ranges from about 4:1 to about 2:1.

15. The chew toy as recited in claim 14, wherein Chlorophyllin is selected from the group consisting of Trisodium Copper Chlorin e6 and Disodium Copper Chlorin e4 and a combination thereof.

16. A method of making a teething toy for an animal which is effective in triggering the teething instinct of the animal, comprising the steps of:
forming of a thermoplastic blend comprising: a first material selected from the group consisting of tricalcium silicate and dicalcium silicate and a combination thereof; and a thermoplastic resin; wherein the weight ratio of said thermoplastic resin and said first material is about 2:1;
molding the thermoplastic blend into a desired configuration; and
curing the thermoplastic blend.

17. The method of claim 16, wherein molding further comprises extrusion.

18. The method of claim 16, wherein the thermoplastic blend further comprises a grass composition.

19. A method of making an edible chew toy for an animal which is effective in providing upset stomach relief for the animal, comprising the steps of:
forming and curing an edible blend selected from the group consisting of turf grass and a starch and a gelatin, wherein the weight ratio of said turf grass and starch or gelatin is about 9:1.

20. The edible chew toy formed by the method recited in claim 19, wherein the edible chew toy is in the configuration of a rope.
